(19) United States
(12) Patent Application Publication
(10) Pub. No.: US 2010/0238291 A1
(43) Pub. Date: Sep. 23, 2010

(54) METHOD AS WELL AS DEVICE FOR DETERMINING THE POSITION AND ALIGNMENT OF A CAMERA OF A DRIVER-ASSISTANCE SYSTEM OF A VEHICLE RELATIVE TO THE VEHICLE

(76) Inventors: Pavel PAVLOV, Muenchen (DE); Stefan Markus Kaefer, Aschheim (DE)

Correspondence Address: KENYON & KENYON LLP, ONE BROADWAY, NEW YORK, NY, 10004, US

(21) Appl. No.: 12/703,909

(22) Filed: Feb. 11, 2010

(30) Foreign Application Priority Data
Mar. 23, 2009 (DE) 10 2009 001 742.9

(51) Int. Cl. B60Q 1/48; H04N 7/18

(52) U.S. Cl. 348/148; 348/E07.085

(57) ABSTRACT

A method for determining the position and the alignment of a camera of a driver-assistance system of a vehicle relative to the vehicle includes the following steps of recording at least one mark of a measuring target affixed on the left wheel of the rear axle, and at least one mark of a measuring target affixed on the opposite, right wheel of the rear axle in at least two vehicle positions, using two measuring cameras, determining the geometrical axis of motion of the vehicle relative to the two measuring cameras therefrom, recording a calibration target of a driver-assistance system, using the two measuring cameras, determining the position of the calibration target of the driver-assistance system relative to the two measuring cameras therefrom, determining the position and the alignment of the calibration target of the driver-assistance system relative to the geometrical axis of motion of the vehicle, recording the calibration target of the driver-assistance system by the camera of the driver-assistance system, determining the position of the camera of the driver-assistance system relative to the calibration target of the driver-assistance system therefrom, and determining the position and the alignment of the camera of the driver-assistance system relative to the geometrical axis of motion of the vehicle.

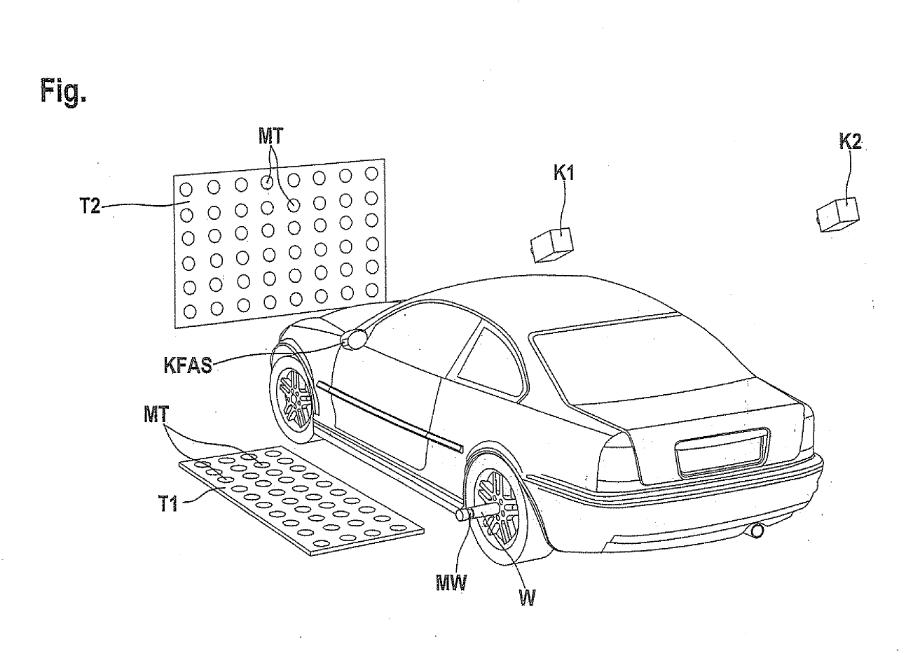

### RELATED APPLICATION INFORMATION

The present application claims priority to and the benefit of German patent application no. 10 2009 001 742.9, which was filed in Germany on Mar. 23, 2009, the disclosure of which is incorporated herein by reference.

### FIELD OF THE INVENTION

The present invention relates to a method and to a device for determining the position and alignment of a camera of a driver-assistance system of a vehicle relative to the vehicle itself.

### BACKGROUND INFORMATION

Modern motor vehicles frequently come equipped with driver-assistance systems, such as a lane-keeping assistant, a lane-change warning, lane departure warning, a thermal imaging (night vision) camera or a parking assistant.

Especially in the case of camera-based driver-assistance systems, the camera of the driver-assistance system must provide a precise image of the environment that conforms to reality and is correctly aligned with respect to the vehicle. This requires the cameras of the driver-assistance systems to be calibrated. In practice, such a calibration operation and, in particular, the preparatory steps for this purpose are frequently very complex. In particular the detection of the positioning and alignment of the camera of the driver-assistance systems relative to the vehicle itself often creates problems.

### SUMMARY OF THE INVENTION

Therefore, it is an object of the exemplary embodiments and/or exemplary methods of the present invention to provide a method and a device that simplify the calibration of cameras of driver-assistance systems.

This object may be attained by the subject matter described herein. Advantageous refinements are further described herein.

In a method according to the present invention for determining the position and alignment of a camera of a driver-assistance system of a vehicle relative to the vehicle, first at least one mark of a measuring target affixed on the left wheel of the unsteered rear axle, and at least one mark of a measuring target affixed on the opposite, right wheel of the unsteered rear axle are recorded by two measuring cameras, i.e., in at least two vehicle positions that differ from one another. From this, the direction of the geometric axis of motion and its position centrically to the axle with respect to the two measuring cameras is determined. Recording the measuring targets in more than two vehicle positions makes it possible to increase the precision of the determined geometric axis of motion. Then a calibration target of the driver-assistance system situated at a distance from the vehicle is recorded by the two measuring cameras, and the position of the calibration target of the driver-assistance system relative to the measuring cameras is determined therefrom.

Knowledge of the geometrical axis of motion relative to the measuring cameras and knowledge of the position of the calibration target of the driver-assistance system relative to the measuring cameras makes it possible to calculate the position and the alignment of the calibration target of the driver-assistance system relative to the geometrical axis of motion of the vehicle based on the joint reference formed by the measuring cameras. Then, the camera of the driver-assistance system records the same calibration target of the driver-assistance system in the same position, and this is used to determine the position of the camera of the driver-assistance system relative to the calibration target of the driver-assistance system. Now, the position of the calibration target of the driver-assistance system both relative to the two measuring cameras and relative to the camera of the driver-assistance system is known, and in addition, the geometrical axis of motion relative to the measuring cameras is known. Therefore, the position and the alignment of the camera of the driver-assistance system relative to the geometrical axis of motion is now able to be determined on the basis of the joint reference formed by the measuring cameras.

In a device according to the present invention for determining the position and the alignment of a camera of a driver-assistance system of a vehicle relative to the vehicle itself, the following are provided: a calibration target, disposed at a distance from the vehicle, for the camera of the driver-assistance system, a left measuring target, mounted on a left wheel of the unsteered rear axle and having at least one mark, and a right measuring target, mounted on the opposite, right wheel of the unsteered rear axle and having at least one mark, two measuring cameras for recording the calibration target of the driver-assistance system and for recording at least one mark of the left measuring target and at least one mark of the right measuring target in a plurality of vehicle positions, as well as an evaluation unit. The evaluation unit uses the recordings of the measuring targets in at least two vehicle positions to determine the direction of the geometrical axis of motion and its position centrically to the axis with respect to the two measuring cameras. Recording the measuring targets in more than two vehicle positions makes it possible to increase the precision of the determined geometric axis of motion.

Furthermore, the evaluation unit uses the recordings of the calibration target of the driver-assistance system by the two measuring cameras to determine the position of the calibration target of the driver-assistance system relative to the measuring cameras; from this, it determines the position and the alignment of the calibration target of the driver-assistance system relative to the geometrical axis of motion of the vehicle; from the recording of the calibration target of the driver-assistance system by the camera of the driver-assistance system, it determines the position of the calibration target of the driver-assistance system relative to the camera of the driver-assistance system, and finally, it determines from this the position and the alignment of the camera of the driver-assistance system relative to the geometrical axis of motion.

According to the exemplary embodiments and/or exemplary methods of the present invention, the camera of the driver-assistance system is able to determine the position of the calibration target of the driver-assistance system relative to itself, but not its actual position with respect to the vehicle. In practice, what is frequently missing for calibrating the cameras of the driver-assistance system is knowledge of the position and alignment of the camera of the driver-assistance system with respect to the vehicle geometry itself. This is due to the fact that the position and alignment of the camera of the driver-assistance system with respect to the vehicle geometry often deviates from the required setpoint values, which necessitates a calibration. This problem is remedied by the exemplary embodiments and/or exemplary methods of the present invention; the position and the alignment of the camera of the driver-assistance system relative to the vehicle itself are able to be determined in a rapid and precise manner. According to the exemplary embodiments and/or exemplary methods of the present invention, a calibration of driver-assistance systems is therefore accelerated and made easier or even made possible in the first place.

An additional suitable target, which is referred to as calibration target of the driver-assistance system in this case, is therefore used according to the exemplary embodiments and/or exemplary methods of the present invention, and the position and alignment of this target relative to the geometrical axis of motion is determined by the measuring cameras. This information may be linked with the information determined by the camera of the driver-assistance system regarding the position and the alignment of the camera of the driver-assistance system relative to the calibration target of the driver-assistance system; finally, it is possible to determine from this the position and the alignment of the camera of the driver-assistance system relative to the geometrical axis of motion. The linking of the information of the geometrical axis of motion relative to the two measuring cameras with the information of the calibration target of the driver-assistance system relative to the two measuring cameras then provides the information about the calibration target of the driver-assistance system relative to the geometrical axis of motion.

In other words, it is ascertained how the coordinate system of the camera of the driver-assistance system, within which it calculates, is situated in position and alignment relative to the geometrical axis of motion.

The calculation steps of the evaluation unit may also be executed in distributed manner; for example, the position of the calibration target of the driver-assistance system relative to the camera of the driver-assistance system may be determined in an evaluation unit of the driver-assistance system, and only the result of the further evaluation unit may be provided.

The wheels on which the measuring targets are mounted are the rear wheels, the more so as the geometrical axis of motion is specified by the rear wheels and the rear axle.

According to the exemplary embodiments and/or exemplary methods of the present invention, the calibration target of the driver-assistance system must lie within the visual ranges of the camera of the driver-assistance system and the two measuring cameras. In the case of a camera of a driver-assistance system pointing forward and situated above the interior mirror of the vehicle, for example, the calibration target of the driver-assistance system must be placed in front of the vehicle. In the case of cameras of a driver-assistance system situated on or inside the outside mirror or the door strut and pointing at an angle downward, the calibration target of the driver-assistance system should be situated next to the motor vehicle. In the case of a camera of a driver-assistance system situated in the rear of the motor vehicle and pointing toward the rear, the calibration target of the driver-assistance system must be placed behind the vehicle.

These placements of the camera of the driver-assistance system are mentioned merely as examples; other placements of cameras of the driver-assistance system are naturally also encompassed by the exemplary embodiments and/or exemplary methods of the present invention.

The specific embodiments of the present invention described in the following text may be used both in the form of methods and devices.

According to a first specific embodiment of the present invention, the inclination of the contact patch relative to the measuring cameras is determined by recording the marks on the measuring targets in the at least two vehicle positions. If the position of the measuring cameras is known, then it may be used to determine the inclination of the contact patch in the vehicle linear direction and/or in the vehicle side direction therefrom. As an alternative, it is possible to determine the inclination of the contact patch in the vehicle linear direction by recording at least one mark on the vehicle body, and the inclination of the contact patch in the vehicle side direction by recording a reference system, e.g., a bar on the floor having at least two marks. This makes it possible to obtain even more precise values with regard to the position and the alignment of the camera of the driver-assistance system relative to the geometrical axis of motion.

According to one further specific embodiment of the present invention, the calibration target of the driver-assistance system has a known feature array for the camera of the driver-assistance system. This is necessary because the camera of the driver-assistance system frequently is a mono camera. For the purpose of monitoring by the two measuring cameras it is sufficient if a not specified in advance or not previously known array of marks is provided on the calibration target of the driver-assistance system. It is therefore conceivable that the calibration target of the driver-assistance system includes a first known mark array for the camera of the driver-assistance system, and a second, unknown mark array for the measuring cameras.

According to one further specific embodiment of the present invention, a display device is provided in addition, which device displays the actual position and possibly also the setpoint position of the calibration target of the driver-assistance system in order to thereby facilitate the placement of the calibration target of the driver-assistance system into the setpoint position. The driver-assistance system is frequently provided with its own calibration software that presupposes that the calibration target of the driver-assistance system is in a defined position relative to the vehicle. Without the exemplary embodiments and/or exemplary methods of the present invention, bringing the calibration target of the driver-assistance system into this defined position is an involved, iterative process. This specific embodiment of the present invention significantly simplifies the placement of the calibration target of the driver-assistance system into the defined position, or it makes it possible in the first place.

According to one further specific embodiment of the present invention, the camera of the driver-assistance system is a camera of a driver-assistance system of a lane-keeping assistant, a lane-change warning, a lane-departure warning, a thermal imaging camera or a parking assistant. This is merely an exemplary enumeration and not meant to be all-inclusive; the present invention naturally also encompasses other cameras of driver-assistance systems.

According to one further specific embodiment of the present invention, the measuring targets include a target element projecting outwardly in the vehicle side direction, on which at least one mark is affixed, which is developed in such a way that at least one mark is always within the visual field of the measuring camera when the measuring target is rotating. In this way, these marks are able to be recorded and the geometrical axis of motion of the vehicle be determined therefrom in any angular position of the wheel, which is especially comfortable.

According to an additional specific embodiment of the present invention, a reference target and/or an angle-measuring device for the measuring cameras are/is provided in order to be able to determine their alignment with respect to the direction of the gravitational force. It is possible, for example, to use as reference target a reference system, especially a bar having at least two marks, which reference system is aligned at a known angle relative to the direction of the gravitational force.

In one advantageous further development of the present invention, the calibration target of the driver-assistance system itself may be used as such a reference target, provided its feature array is aligned at a known angle relative to the direction of the gravitational force.

According to one further aspect of the exemplary embodiments and/or exemplary methods of the present invention, conventional calibration systems as used for radar, lidar, ultrasonic sensors and the like may be employed, or adjustment aids for headlights may be provided with measuring marks or retroactively equipped with such, to make it possible to determine their position and alignment through monitoring with the aid of the measuring cameras.

One further development of the exemplary embodiments and/or exemplary methods of the present invention also provides the possibility to determine the position and the alignment or placement of additional calibration or adjustment aids, e.g., radar, lidar or ultrasonic sensors or, for example, headlight adjustment devices, relative to the vehicle geometry.

The exemplary embodiments and/or exemplary methods of the present invention is elucidated in greater detail in the following text on the basis of an exemplary embodiment, with reference to the attached drawing.

### BRIEF DESCRIPTION OF THE DRAWING

The FIGURE shows a perspective view of a device for determining the position and alignment of a camera of a driver-assistance system of a vehicle relative to the vehicle itself.

### DETAILED DESCRIPTION

The FIGURE shows an oblique rear view of a vehicle whose camera of the driver-assistance system is to be calibrated. Mounted on its left rear wheel with the aid of, for example, a magnetic holder of the wheel bolts (not shown in the FIGURE) is a wave-shaped measuring target W. As an alternative, wave-shaped measuring target W may also be mounted with the aid of a quick-action clamping holder known from axle measurements.

In the FIGURE, wave-shaped target W forms an extension of the axis of rotation of the left rear wheel, which is optional, however. Wave-shaped measuring target W may also extend at a radial distance to the wheel's axis of rotation.

Wave-shaped measuring target W projects a little to the outside in the vehicle side direction and has in its outer region an annular measuring mark MW, which is affixed on wave-shaped measuring target W in a rotationally symmetrical manner, so that this annular measuring mark MW always remains visible to measuring cameras K1 and K2, which will be discussed in the following text, while wave-shaped measuring target W is rotating because of a vehicle movement, especially in a power take-off of the vehicle.

As an alternative to the annular design of measuring mark MW, it is also conceivable to distribute a plurality of discrete measuring marks across the circumference of wave-shaped measuring target W.

As an alternative to the advantageous wave-shaped design of measuring target W shown here, it is also possible to mount conventional targets on the wheels; these targets may then be monitored by measuring cameras K1 and K2 possibly only at certain angular ranges of the wheel position.

A wave-shaped measuring target W, which is covered by the rear of the vehicle in this instance, is affixed on the right rear wheel as well.

Integrated in the left outside mirror of the vehicle is a camera KFAS of the driver-assistance system, which, for instance, is an element of a lane-keeping assistant. This camera is aligned at an angle downward, so that first calibration target Tl of the driver-assistance system, which will be discussed in the following text, lies within its field of view.

Another camera, which points forward and is not visible here, of a driver-assistance system is mounted on the interior rear-view mirror of the vehicle; its field of view is configured such that calibration target T2 of the driver-assistance system standing upright in front of the vehicle lies fully within its field of view.

First calibration target Ti of the driver-assistance system, which lies horizontally next to the vehicle, and second calibration target T2 of the driver-assistance system include an array of measuring marks MT, whose form and mutual alignment are known.

Provided above the rear region of the vehicle are two measuring cameras K1 and K2, whose fields of views are configured, or are adjustable, in such a way that for one, annular measuring marks MW on both sides of the vehicle lie completely within it when the vehicle is moving in a power take-off and, for another, in the event that camera KFAS of the driver-assistance system is to be calibrated, the first calibration target of the driver-assistance system lies fully within it, or, in the event that the camera of the driver-assistance system in the interior mirror is to be calibrated, calibration target T2 of the driver-assistance system lies fully within it.

In an alternative exemplary embodiment, it is conceivable for measuring cameras K1 and K2 to have a design that allows swivel movements so as to measure the vehicle and the calibration target of the driver-assistance system one after the other should it be impossible for them to lie in the field of view at the same time. However, the swivel motion of measuring cameras K1 and K2 must then be known or measured!

Furthermore, the calibration device also includes an evaluation unit, which is not shown in the FIGURE and which carries out the following calculations and outputs or indicates corresponding results.

The following text describes the determination of the position and the alignment of camera KFAS of the driver-assistance system relative to the vehicle; for the camera of the driver-assistance system situated in the interior mirror of the vehicle, this determination is performed in analogous manner.

In a power take-off of the vehicle, annular measuring marks MW are monitored by measuring cameras K1 and K2, and the direction of the geometrical axis of motion and its position as center of the rear axle relative to measuring cameras K1 and K2 is calculated therefrom. In this context it is assumed that both annular measuring marks MW have the same design and are mounted symmetrically on the rear wheels of the vehicle.

Monitoring the annular measuring marks also makes it possible to determine the inclination of the contact patch relative to measuring cameras K1 and K2.

Afterwards, feature array MT on first calibration target T1 of the driver-assistance system is recorded at the same instants while the vehicle is in motion or while the vehicle is standing still, the recording being made by the two measuring cameras K1 and K2, for one, and by camera KFAS of the driver-assistance system, for another. On the basis of the recordings of calibration target T1 of the driver-assistance system and its feature array MT by the measuring cameras, it is possible to determine its position and alignment with respect to the geometrical axis of motion. The position and alignment of calibration target T1 of the driver-assistance system with respect to camera KFAS of the driver-assistance system are determined via the recording of calibration target T1 of the driver-assistance system and its measuring-mark array MT by the camera of the driver-assistance system.

The data of the geometrical axis of motion obtained in this manner and the positional and alignment data of the calibration target of the driver-assistance system have a fixed, precisely known relationship to each other because of the jointly monitoring measuring cameras K1 and K2, which may also be referred to as a stereo camera array, so that it is then possible to determine therefrom the position and alignment of camera KFAS of the driver-assistance system relative to the geometrical axis of motion.

Since the position of the calibration target of the driver-assistance system both relative to the two measuring cameras and relative to the camera of the driver-assistance system is known, and since the geometrical axis of motion of the vehicle relative to the measuring cameras is known as well, the position and alignment of the camera of the driver-assistance system relative to the geometrical axis of motion of the vehicle are then able to be determined.

Knowledge of the position and alignment of the camera of the driver-assistance system relative to the geometrical axis of motion is required for the subsequent calibration of the driver-assistance system, which often is performed by software internal to the driver-assistance system.

If the evaluation unit is equipped with a display, then it is possible to show calibration target T1 of the driver-assistance system in its instantaneous position relative to the geometrical axis of motion in order to facilitate the positioning of calibration target T1 of the driver-assistance system into the setpoint position specified by the driver-assistance system for the calibration.

Furthermore, since the precise positioning and alignment of camera KFAS of the driver-assistance system relative to the geometrical axis of motion is now known, it is ensured that camera KFAS of the driver-assistance system is optimally aligned and adjusted following the calibration operation.

What Is Claimed Is:

1. A method for determining a position and an alignment of a camera of a driver-assistance system of a vehicle relative to the vehicle, the method comprising:
recording at least one mark of a measuring target mounted on a left wheel of a rear axle, and at least one mark of a measuring target mounted on an opposite, right wheel of the rear axle, using two measuring cameras, in at least two vehicle positions;
determining a geometrical axis of a motion of the vehicle relative to the two measuring cameras therefrom;
recording a calibration target of a driver-assistance system, using the two measuring cameras;
determining the position of the calibration target of the driver-assistance system relative to the two measuring cameras therefrom;
determining the position and the alignment of the calibration target of the driver-assistance system relative to the geometrical axis of motion of the vehicle;
recording the calibration target of the driver-assistance system by the camera of the driver-assistance system;
determining the position of the camera of the driver-assistance system relative to the calibration target of the driver-assistance system therefrom; and
determining the position and alignment of the camera of the driver-assistance system relative to the geometrical axis of motion of the vehicle.

2. The method of claim 1, wherein an inclination of a contact patch relative to the measuring cameras is determined by recording the marks on the measuring targets.

3. The method of claim 1, wherein the measuring cameras record the marks of the measuring targets on the wheels while the vehicle is in motion, including during a power take-off of the vehicle.

4. The method of claim 1, wherein the calibration target of the driver-assistance system has a feature array.

5. The method of claim 1, further comprising:
a display device to display an actual position and the setpoint position of the calibration target of the driver-assistance system, so as to facilitate the positioning of the calibration target of the driver-assistance system into the setpoint position.

6. A method for calibrating a camera of a driver-assistance system of a vehicle relative to a target, the method comprising:
determining a position and an alignment of a camera of a driver-assistance system of a vehicle relative to the vehicle, by performing the following:
recording at least one mark of a measuring target mounted on a left wheel of a rear axle, and at least one mark of a measuring target mounted on an opposite, right wheel of the rear axle, using two measuring cameras, in at least two vehicle positions,
determining a geometrical axis of a motion of the vehicle relative to the two measuring cameras therefrom,
recording a calibration target of a driver-assistance system, using the two measuring cameras,
determining the position of the calibration target of the driver-assistance system relative to the two measuring cameras therefrom,
determining the position and the alignment of the calibration target of the driver-assistance system relative to the geometrical axis of motion of the vehicle,
recording the calibration target of the driver-assistance system by the camera of the driver-assistance system,
determining the position of the camera of the driver-assistance system relative to the calibration target of the driver-assistance system therefrom, and
determining the position and alignment of the camera of the driver-assistance system relative to the geometrical axis of motion of the vehicle; and
subsequently calibrating the camera of the driver-assistance system relative to the calibration target of the driver-assistance system.

7. A device for determining a position and an alignment of a camera of a driver-assistance system of a vehicle relative to the vehicle, comprising:
a calibration target, situated at a distance from the vehicle, for the camera of the driver-assistance system;
a left measuring target, affixed on a left wheel of a rear axle and having at least one mark, and a right measuring target, affixed on an opposite, right wheel of the rear axle and having at least one mark;
two measuring cameras, which are placed and configured to record the calibration target of the driver-assistance system, and to record at least one mark of the left measuring target and at least one mark of the right measuring target in a plurality of vehicle positions; and
an evaluation unit, which is configured to performed the following:
determine from the recordings of the measuring targets in at least two vehicle positions the geometrical axis of motion of the vehicle relative to the two measuring cameras,
determine from the recordings of the calibration target of the driver-assistance system by the two measuring cameras the position of the calibration target of the driver-assistance system relative to the two measuring cameras,
determine the position and the alignment of the calibration target of the driver-assistance system relative to the geometrical axis of motion of the vehicle therefrom,
determine from the recording of the calibration target of the driver-assistance system by the camera of the driver-assistance system the position of the calibration target of the driver-assistance system relative to the camera of the driver-assistance system, and
determine therefrom the position and the alignment of the camera of the driver-assistance system relative to the geometrical axis of motion of the vehicle.

8. The device of claim 7, wherein the camera of the driver-assistance system is a camera of a driver assistance system of at least one of a lane-keeping assistant, a lane-change warning, a lane-departure warning, a thermal imaging/night vision camera and a parking assistant.

9. The device of claim 7, wherein the measuring targets have a target element projecting outwardly in the vehicle side direction, and including at least one mark affixed thereon, which is configured so that at least one mark is always within a visual field of the measuring cameras in a rotation of the measuring target.

10. The device of claim 7, further comprising:
at least one of a reference target and an angle-measuring device for the measuring cameras.
